(19) United States
(12) Patent Application Publication
(10) Pub. No.: US 2006/0070760 A1
(43) Pub. Date: Apr. 6, 2006

(54) Reciprocating attachment for power drills

(75) Inventors: David Bernard, Ashland, OR (US); William Christian, Ashland, OR (US); Scott Harris, Eagle Point, OR (US); Keith Mosttler, White City, OR (US); Hank O'Dougherty, Ashland, OR (US); Daniel Dovel, Shady Cove, OR (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: Professional Tool Manufacturing, LLC, Ashland, OR (US)

(21) Appl. No.: 10/543,346

(22) PCT Filed: May 24, 2004
(86) PCT No.: PCT/US04/16277

§ 371 Date: Jul. 22, 2005

Related U.S. Application Data
(60) Provisional application No. 60/472,730, filed on May 23, 2003.

(51) Int. Cl. B25D 16/00

(52) U.S. Cl. 173/109

(57) ABSTRACT

A motion conversion assembly is provided, wich is adapted to be attached to a power drill for converting rotational motion of the drill to a reciprocating motion to operate as a reciprocating saw. The motion conversion assembly is mounted in a housing, and employs an offset-angled spindle on a rotatable drive shaft which is coupled to an intermediate shaft sub-assembly in the housing, which cooperated whith the offset-angled apindle to produce a reciprocating motion in the intermediate shaft subassembly as the rotatable drive shaft is rotated.

### BACKGROUND OF THE INVENTION

1. Field of the Invention

The present invention relates to devices for converting a rotational motion into a reciprocating motion. More particularly, the invention relates to such devices as would be used as an attachment to a power drill to operate as a reciprocating saw.

2. Description of Related Art

Various attachments for power drills have been developed in the art. Many simply employ the rotational motion provided by the drill motor to the chuck, such as sanders and polishers. Power drill attachments intended to drive circular saws have also been developed.

U.S. Pat. No. 5,607,265, issued to Lane, and U.S. Pat. No. 6,264,211, issued to Granado, are representative examples of power drill attachments that have been designed to convert the rotational motion of the power drill into a reciprocating motion, such that the drill and attachment can function as a reciprocating saw. Several patents have issued to Bourke that disclose devices for converting rotary drill motion to a reciprocating saw motion. These patents include U.S. Pat. No. 5,755,293; No. 5,595,250; and No. 5,566,768. Attachments that allow one power tool to function in the manner of another type of power tool are seen as desirable to consumers, in that the attachment will generally cost considerably less then the cost of purchasing the other type of tool, and in that the attachments are more compact than a separate power tool, thus conserving space and making the tool more portable.

Each of the devices disclosed in the above-mentioned patents has certain drawbacks or disadvantages that have likely prevented large-scale production and commercialization. Ease of production, cost to manufacture, reliability of design and ease of use are all factors which must be taken into account in the design of this type of attachment. As an example, the gear arrangement employed in the Granado patent would be quite expensive if tolerances in the gear train are kept tight. On the other hand, if tolerances are loosened, the attachment would generate an unacceptable level of vibration, making the attachment difficult to use. The loads imposed on components of other designs, such as that in the Lane patent, can lead to premature failure of the unit, and/or other reliability problems.

It is a main object of the present invention to provide a power drill attachment which will function as a reciprocating saw, or otherwise function using a reciprocating motion, that overcomes the various disadvantages present in known designs for this type of attachment.

### SUMMARY OF THE INVENTION

The above and other objects of the present invention are achieved in the design and construction of the drill attachment described in detail below.

A motion conversion assembly is mounted in a housing, with a drive shaft of the conversion assembly protruding from a back end of the housing, and a saw rod or saw mounting rod protruding from a front end of the housing. The housing is contoured so as to conform to the grip of a user of the attachment, in situations in which the user wishes to exert greater control over the sawing operation.

Inside the housing, the motion conversion assembly includes an intermediate shaft subassembly that is operatively coupled to the drive shaft and to the saw rod. The drive shaft is rotatingly retained in a forward bearing assembly, and the rear portion of the drive shaft that protrudes from the back end of the housing is designed to be secured in the chuck jaws of a power drill. The drive shaft is rotated by the power drill, once secured in the chuck.

The intermediate shaft subassembly includes an intermediate shaft having a bearing housing and a yoke pin extending outwardly from the bearing housing. Two bearings are installed in the bearing housing, and receive therein an offset-angled spindle situated at the terminal end of the drive shaft.

The yoke pin fits inside of a bore in a transfer pin positioned transversely to the main axis of the drive shaft. The transfer pin in turn is fitted into a corresponding opening in the saw bar or saw shaft.

The offset-angled spindle at the end of the drive shaft is rotates freely within the bearings mounted in the intermediate shaft, and, when the drive shaft is rotated, the spindle causes the bearing housing and the associated yoke pin to move. More specifically, the yoke pin will, due to constraints imposed by the mechanical linkages or interfaces, move forward and rearward in a plane in which the main drive shaft axis lies, and the yoke pin will be able to rotate about its own axis within the bore of the transfer pin.

The forward and rearward motion of the yoke pin causes the transfer pin to reciprocate in the same forward and rearward motion, which, in turn, reciprocates the saw shaft holding a saw blade. In this manner, the rotary motion of a power drill chuck is converted to a reciprocating saw motion.

The design of the present invention has numerous advantages over prior designs, including a lower cost to manufacture, higher reliability, and reduced heat and vibration in operation, for example. In addition, the present design produces the desired reciprocating motion on a one-for-one basis with the rotary motion, i.e. one cycle of rotary motion produces one cycle of reciprocal motion. The useful energy obtained from this conversion in the present design is within 90% of the input energy, making it a highly efficient device. Energy loss is minimized through a combination of low inertia (minimal mass of parts) and the elimination of any potential binding point as the rotary motion converts to reciprocating motion.

Additional unique features of the design of the present invention include that the saw mechanism operates independently of orientation with respect to the body of the drill. An offset blade-mounting feature is also provided to permit easier viewing of the cut being made, and also to allow a cut to be made close to a solid surface, such as a wall or floor. The blade may be attached with the cutting edge facing either downwardly or upwardly, to enable “up-cutting” to be performed as necessary or desired, without turning the drill upside-down.

### BRIEF DESCRIPTION OF THE DRAWINGS

The above advantages and features of the present invention will become better understood by having reference to the detailed description of the invention, taken in conjunction with the accompanying drawings, in which like elements are designated by like numerals and in which:

FIG. 1 is an exploded perspective view of the drill attachment according to a preferred embodiment of the invention;

FIG. 2 is a side cutaway view of the drill attachment in accordance with a preferred embodiment of the invention;

FIG. 3 is a side view of the input shaft in accordance with a preferred embodiment of the present invention motion conversion assembly;

FIGS. 4 and 5 are side elevation views of the exterior of the left and right housing components which are joined to make the drill attachment housing in accordance with a preferred embodiment of the present invention.

FIG. 6 is a perspective view of the saw shaft according to a preferred embodiment of the present invention.

### DETAILED DESCRIPTION OF THE PREFERRED EMBODIMENT

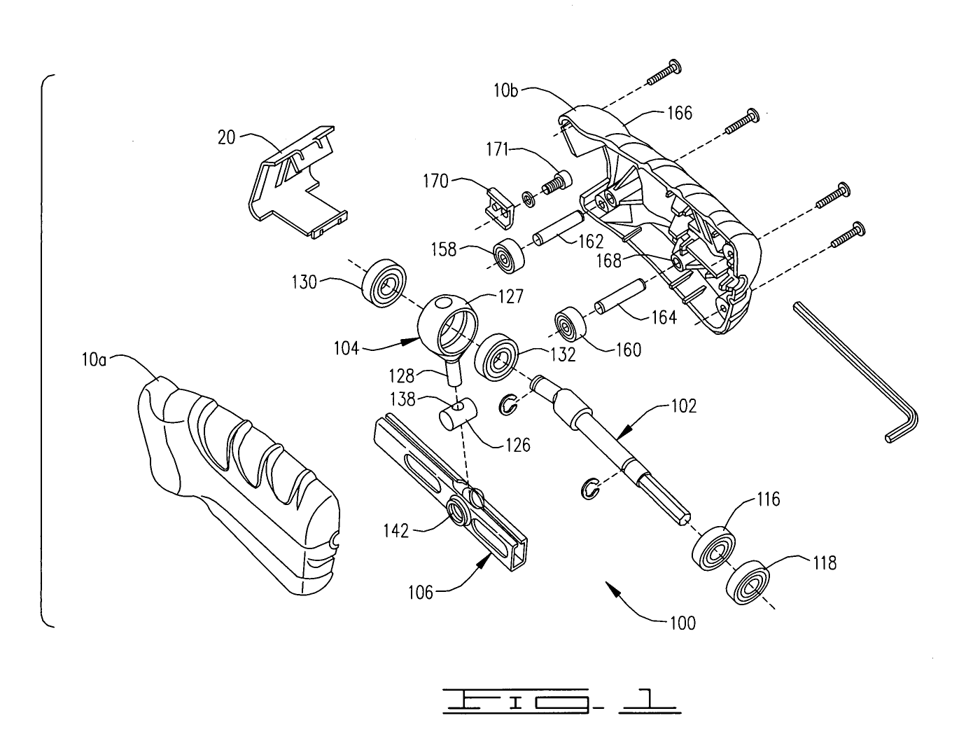

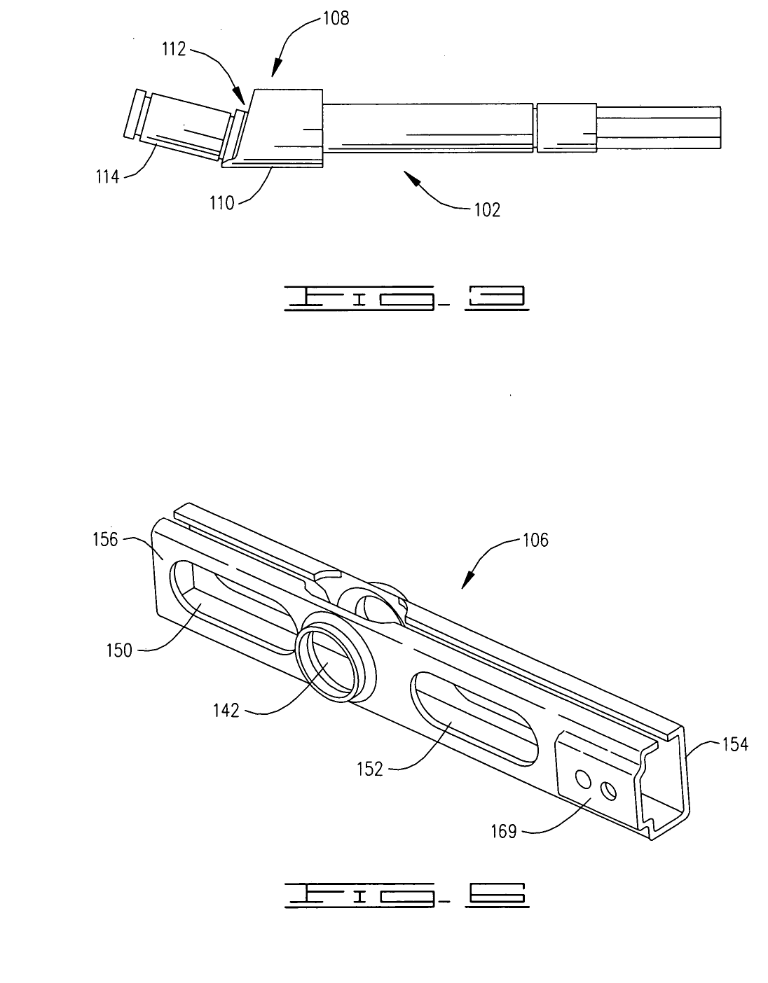

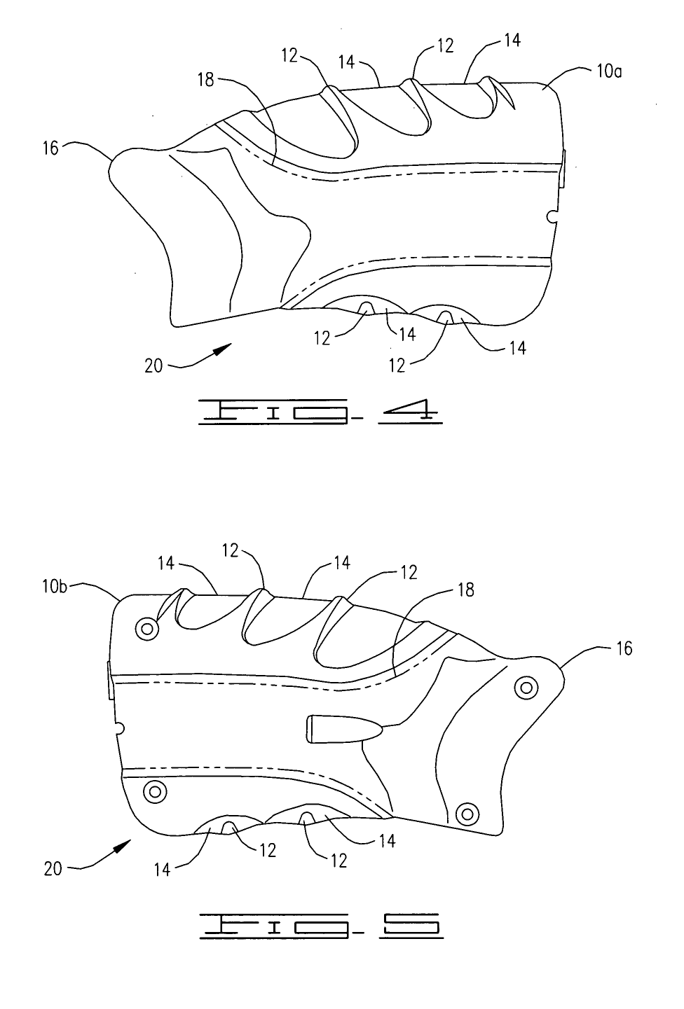

Referring initially to the exploded perspective view of FIG. 1, a housing 10 is provided in two sections 10a, 10b, which are secured together to encase the motion conversion subassembly 100. The housing (see also FIGS. 4, 5) has an external shape designed to allow a user to take a comfortable grip on the housing either at the top or side thereof. Ribs 12 and recesses 14 formed between the ribs facilitate gripping by the fingers of the user. A protrusion 16 at the forward end of the housing will prevent the user's hand from slipping forward, potentially into the path of the saw blade.

The housing 10 is constructed of a molded hard plastic, and preferably has a softer polymeric overlay material, such as a urethane product marketed under the name Pellethane, at the upper and lower gripping regions 18, 20. This housing construction can be produced in a manner well-known in the art. The resilient polymeric overlay material increases the comfort of handling the saw attachment in use, and its texture aids in preventing the user's hand from slipping.

Housing 10, once the two halves are assembled together, contains motion conversion assembly 100. The motion conversion assembly 100 is made up of a drive shaft 102, an intermediate shaft subassembly 104, and a saw shaft 106. The saw shaft 106 may alternatively be referred to as a saw rod or a saw-holding rod. The motion conversion assembly 100 is assembled and retained in place by housing 10, with a rear end of drive shaft 102 protruding out of the housing at a rear portion thereof. At the forward end of the housing 10, the front portion of saw shaft 106 protrudes therefrom through an appropriate opening in the housing.

The rear portion of drive shaft 102 is preferably hexagonal in cross-section, in order that it can be securely retained in the jaws of a drill chuck. Other polygonal cross-sectional shapes may also be employed, as can a circular cross-section. The forward portion of drive shaft 102 preferably has a circular cross-section, and terminates at an offset-angled spindle 108.

Spindle 108 is made up of a cylindrical member 110 having a larger diameter than the diameter of drive shaft 102, and having an inclined surface 112 at a forward end. Protruding from this forward end is spindle pin 114. Spindle pin is preferably oriented at an angle of between about 5° and 45°, and more preferably at an angle of about 15° relative to a main axis of revolution of the drive shaft 102. Spindle pin 114 is further preferably positioned such that a central axis of the pin 114 intersects the drive shaft main axis at a point located at or near the center of the length of spindle pin 114. This point of intersection, however, may lie anywhere along the length of spindle pin 114, within the scope of this invention.

Drive shaft 102 is preferably supported in position within housing 10 by a pair of support bearings 116, 118, which themselves are secured in place within appropriate fittings or ribs 120, 122, extending inwardly from the inner surface of housing 10. Drive shaft 102 is thereby permitted to rotate within housing 10, without any substantial power or energy loss due to the mounting of the shaft.

Intermediate shaft assembly 104 is preferably made up of intermediate shaft 124 and transfer pin 126. Intermediate shaft 124 preferably includes a bearing housing 127, a yoke pin 128 extending outwardly from the bearing housing, and first and second spindle bearings 130, 132. The spindle bearings are fitted into openings or recesses at the front and rear ends of bearing housing 127. Bearing housing itself is preferably designed to retain the bearings at the outer periphery of the bearings, as by press-fitting or other means of securement.

Spindle pin 114 of drive shaft 102 is sized to be inserted through a central opening provided in each of bearings 130, 132, and may preferably be secured in position extending through the openings by an E-ring 134 engaged in a groove 136 provided at or near the terminal end of spindle pin 114.

Yoke pin 128 extends outwardly from the outer surface of bearing housing 127. In the illustrated preferred embodiment, intermediate shaft 124 is oriented such that the yoke pin 128 extends downwardly from bearing housing 127. Intermediate shaft 124 may alternatively be oriented such that the yoke pin extends upwardly or to either side, provided that the overall configuration of the unit and the orientation of parts is altered. Yoke pin 128 is sized to fit within a bore 138 provided in transfer pin 126, such that yoke pin 128 can rotate or oscillate about its longitudinal axis within the bore. The fit is preferably not so loose as to allow an appreciable amount of movement in other directions. Transfer pin 126 is oriented such that its longitudinal axis runs transversely to the axis of rotation of drive shaft 102. Transfer pin further is sized such that it will extend from a position below bearing housing 127 laterally over to and through an opening 142 in saw shaft 106.

Saw shaft 106 is preferably in a substantially parallel orientation relative to the axis of rotation of drive shaft 102. The saw shaft is preferably constructed in the general shape of a rectangular bar member. In the illustrated preferred embodiment, shaft 106 is constructed from steel sheet, such that the generally rectangularly-shaped bar is hollow through its center, and is not fully closed at its top surface. The lightweight, open construction gives the saw shaft a low mass while maintaining sufficient stiffness and strength, which aids in reducing vibration and heat buildup that has been commonly experienced in earlier designs.

In addition to having an opening 142 extending through an approximately central region of the saw shaft 106 to receive transfer pin 140 therein, the shaft has two sets of elongated slots 150, 152 extending through and along opposing side walls 154, 156 of the shaft 106. These sets or pairs of slots are provided so that the shaft can be mounted in the housing in a manner that permits reciprocating longitudinal motion or movement, but which substantially prohibits movement of the saw shaft 106 in any other direction.

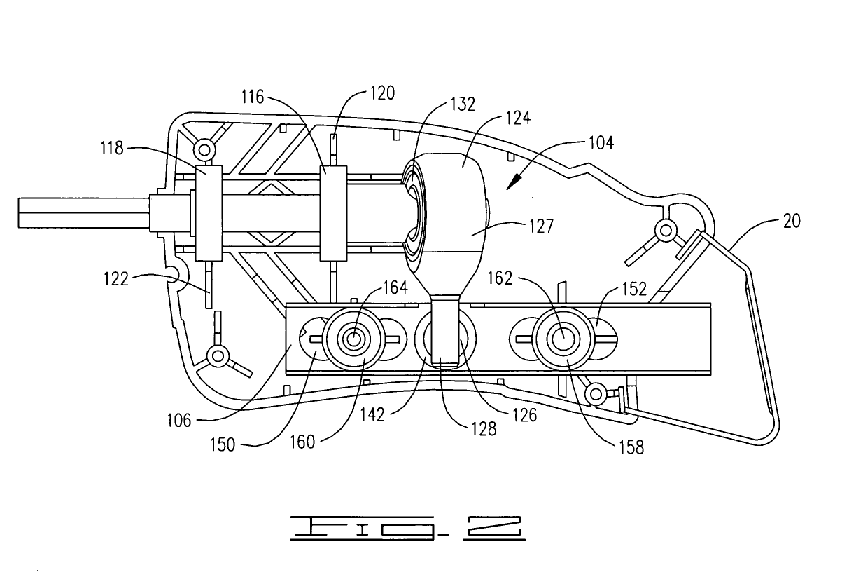

The saw shaft mounting means includes first and second saw shaft bearings 158, 160 sized to be fitted within the hollow center portion of the saw shaft (see FIGS. 1 and 2), one forward and one rearward of the area occupied by transfer pin 140, once assembled. The bearings 158, 160 themselves are mounted in fixed positions within the housing 10, by first and second bearing axles 162, 164, which extend through central openings in shaft bearings 158, 160. The ends of bearing axles 162, 164 are fitted, as by press-fitting, for example, into ferrules or sleeves 166, 168, protruding from the inner wall of housing 10.

One of the side walls 154, 156, is preferably provided with a raised section or surface 169 (see FIG. 6) having at least one threaded bore therein, with the surface being sized and shaped to receive a complementary-shaped saw blade clamp 170 (FIG. 1) thereon, with the blade clamp being fastenable to the saw shaft 106 via a socket cap screw 171, a thumbscrew, or any other known type of suitable fastener. In operation, the rear end of an appropriately configured saw blade is clamped between the raised section 169 of the saw shaft and the saw blade clamp 170. Also, as can be seen in FIG. 2, the forward end of housing 10 may be provided with a saw foot 20, which partially surrounds the saw shaft and the rear end of the saw blade fastened therein, in a manner similar to various saw feet employed on dedicated power saws known in the art.

As noted previously, this blade securing means is designed so as to enable the blade to be secured therein with its saw teeth facing either upwardly or downwardly, as desired. In that manner, the device can be used to cut in either a downward or an upward direction. Further, the overall design and configuration of the unit results in the saw blade being offset to one side relative to a central plane where the housing members join. This enables the saw device to be used at a close spacing from adjacent solid surfaces, such as near a corner where two wall sections meet.

Once assembled into a unit, the device is capable of producing a linear reciprocating cutting motion at the saw shaft 106, using the rotary motion input from a power drill or other power tool providing rotary motion. The mechanical sequence for accomplishing this is centered around the interaction of intermediate shaft 124 and the offset-angled spindle 108 driven by the rotary motion of the drive shaft 102.

As torque is applied from the power drill (not shown), the drive shaft 102 (also referred to as an input shaft) rotates, causing the offset-angled spindle 108 to precess about the point on its longitudinal axis which is coincident with the axis of rotation of the drive shaft. The intermediate shaft 124 is constrained to follow the precessing motion because of its engagement with the spindle pin 114. The intermediate shaft 124 does not, however, rotate about the spindle axis, due to the linkages and connections between the components.

Specifically, the yoke pin 128 extending from the intermediate shaft is constrained to move in two ways. Primarily, it is free to rotate, like a pendulum, backward and forward in the plane of the drive shaft/saw shaft motion axes. The center of the pendulum rotation is the precession point. The axis of the pendulum rotation passes through the precession point and is normal to, i.e., is perpendicular to, the plane formed by the motion axes of the drive shaft and saw shaft.

The yoke pin 128 is also free to rotate on its own central longitudinal axis. On this axis of motion, the pin simply rotates freely, due to the small clearance afforded by the bore in transfer pin 140, into which yoke pin 128 extends. Because the axis of the yoke pin passes through the precession point of the spindle pin 114, it experiences little or no torque reaction from the drive shaft/intermediate shaft coupled subassembly.

The precessing motion of the offset-angled spindle pin 114 causes the intermediate shaft 124, because of the manner in which it is mounted and coupled to other elements, to simultaneously rotate in two axes. One axis, coincident with the longitudinal axis of the yoke pin 128, produces an oscillating motion of the yoke pin about this axis. The second axis, which is normal to the yoke pin axis and lies in a common plane with the motion axes of the drive shaft and saw shaft, produces an oscillating rotary motion about the precession point. On this axis, the yoke pin rotates like a pendulum. The pendulum motion is transmitted to transfer pin 140 though which yoke pin is inserted. Transfer pin, in turn, transmits this motion to the saw shaft 106 by virtue of its coupling to the saw shaft through opening 142.

The transfer pin 140, and its coupling to the saw shaft, divides the pendulum motion into two linear components, one along the motion axis of the saw shaft 106, and one normal to the motion axis in the plane of motion of the drive shaft and saw shaft. The simultaneous rotation of the transfer pin 140 in its mounting at saw shaft 106, and sliding of the yoke pin 128 in the bore through transfer pin 140, removes the normal motion component from the saw shaft. Finally, the remaining linear component is transmitted to the saw shaft through the transfer pin as a linear reciprocating motion along the longitudinal axis of the saw shaft.

This construction and arrangement provides a highly efficient device for converting rotary motion to linear reciprocating motion. The design further overcome several problems that have plagued prior devices intended to perform the same function.

The above description and the associated drawings of a preferred embodiment of the present invention are presented for illustrative purposes only, and are not intended to limit the scope of the invention. Variations and modifications of the disclosed embodiment may become apparent to persons of ordinary skill in the art upon reading this disclosure, and such variations and modifications are considered to be within the scope of the invention, as well.

What is claimed is:

1. A drill attachment comprising:
a motion conversion assembly mounted in a housing, said motion conversion assembly further comprising:
a rotatable drive shaft protruding from a first end of said housing and having an offset-angled spindle at a terminal end thereof inside said housing,
a tool mounting device positioned at a second end of said housing,
an intermediate shaft subassembly including a bearing assembly and a yoke pin extending outwardly from the bearing assembly,
said intermediate shaft subassembly being coupled to said offset-angled spindle of said drive shaft such that a reciprocating motion of said yoke pin is produced when said drive shaft is rotated, and
a transfer element operatively coupled to said yoke pin and to said tool mounting device such that a reciprocating motion of said yoke pin causes said tool mounting device to move with a reciprocating motion.

2. A drill attachment as set forth in claim 1, wherein said transfer element comprises a transfer pin oriented transversely to a main axis of said drive shaft, and wherein said transfer pin has a bore therein to receive said yoke pin in a manner allowing said yoke pin to rotate about its own axis.

3. A drill attachment as set forth in claim 2, wherein said transfer pin is coupled to said tool mounting device through an opening provided in said tool mounting device.

4. A drill attachment as set forth in claim 1 wherein said tool mounting device is so constructed and arranged to permit the mounting of a saw blade thereto.

5. A drill attachment as set forth in claim 1 wherein said intermediate shaft assembly is coupled to said offset-angled spindle via an opening in at least one bearing element housed within said bearing housing, said spindle being positioned to protrude through said opening, and being operable to rotate relative to the bearing housing.

6. A drill attachment as set forth in claim 5, wherein said transfer element comprises a transfer pin oriented transversely to a main axis of said drive shaft, and wherein said transfer pin has a bore therein to receive said yoke pin in a manner allowing said yoke pin to rotate about its own axis.

7. A drill attachment as set forth in claim 6, wherein said transfer pin is coupled to said tool mounting device through an opening provided in said tool mounting device.

8. A drill attachment as set forth in claim 5 wherein said tool mounting device is so constructed and arranged to permit the mounting of a saw blade thereto.

9. A drill attachment as set forth in claim 1, wherein said housing has a shape which enables a comfortable grip to be obtained by a user.

10. A drill attachment as set forth in claim 1, wherein said housing has a polymeric overlay material secured thereto at a location selected from the group consisting of: an upper gripping region, a lower gripping region, both upper and lower gripping regions.

11. A drill attachment as set forth in claim 1 wherein said housing is substantially hollow and includes at least one fitting adapted to support said drive shaft in position within said housing.

12. A drill attachment as set forth in claim 11, wherein said drive shaft has at least one support bearing surrounding said drive shaft, and said at least one fitting maintains said at least one support bearing in position.

13. A drill attachment as set forth in claim 1 wherein said tool mounting device further comprises a tool reciprocation shaft disposed within said housing and a tool fastening element disposed at a terminal end of said tool reciprocation shaft, and wherein said tool fastening element is exposed to the exterior of a said housing via an opening in said housing.

14. A drill attachment as set forth in claim 13 wherein said tool reciprocation shaft is positioned in a substantially parallel orientation relative to said drive shaft, and is in the shape of an elongated, hollow bar member.

15. A drill attachment as set forth in claim 14, wherein said tool reciprocation shaft has at least one shaft bearing disposed in a hollow portion of said tool reciprocation shaft, and said at least one shaft bearing is essentially fixed in position, and wherein said shaft bearing is operable to limit movement of said tool reciprocation shaft in a reciprocating manner substantially parallel to an axis of said drive shaft.

16. A drill attachment as set forth in claim 1 wherein said spindle is oriented at an angle of about 5° to about 45° relative to a main axis of revolution of said drive shaft.

17. A drill attachment as set forth in claim 16 wherein said spindle is oriented at an angle of about 15° relative to a main axis of revolution of said drive shaft.

18. A drill attachment as set forth in claim 16 wherein a central axis of said spindle intersects a main axis of said drive shaft at a point at approximately a center of a length of said spindle.

19. A drill attachment as set forth in claim 16 wherein said spindle generates a precessing motion upon rotation or revolution of said drive shaft.
